(19) United States
(12) Patent Application Publication
(10) Pub. No.: US 2013/0321614 A1
(43) Pub. Date: Dec. 5, 2013

(54) DRIVING SAFETY DEVICE

(71) Applicant: An-Sheng Liu, Zhanghua (CN)

(72) Inventor: An-Sheng Liu, Zhanghua (CN)

(21) Appl. No.: 13/990,986

(22) PCT Filed: May 19, 2011
(86) PCT No.: PCT/CN2011/074341

§ 371 Date: Aug. 20, 2013

(30) Foreign Application Priority Data
Dec. 2, 2010 (CN) 201020638316.0
Jan. 25, 2011 (CN) 201120023609

(51) Int. Cl. B60R 21/00

(52) U.S. Cl. CPC B60R 21/00
USPC 348/115

(57) ABSTRACT

A driving safety device relates generally to a vehicle device designed to prevent dead angle or subsequent traffic accidents due to blocking of visual lines by the buildings or columns, and also to guarantee smooth turning avoiding traffic accidents. The driving safety device has at least two cameras set within the range defined from ⅓ front side of the engine hood to the rear side of the bumper bar. These two cameras are covered by a casing, and fixed at a relative location of the central axis of the vehicle body along with the casing. Moreover, these two cameras cover separately the left and right sides in front of the vehicle, and also are linked to a controller in the vehicle, so as to simultaneously display images on the screen via the driving of the controller.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

REFERENCE TO AN APPENDIX SUBMITTED ON COMPACT DISC

Not applicable.

### BACKGROUND OF THE INVENTION

1. Field of the Invention

The present invention relates generally to a vehicle device, and more particularly to a driving safety device.

2. Description of Related Art Including information Disclosed Under 37 CFR 1.97 and 37 CFR 1.98

When driving in an alley, the drivers' vision may be blocked by buildings when exiting the alley, thus need to stop at the road junction and drive slowly until the road conditions can be seen. During the process, the drivers are driving without seeing the coming vehicles from the side, and may not have time to step on the brake when motorcycles approach the vehicle, thus leading to personal injury or property damage. Such situation is dangerous and requires the drivers to be careful. Moreover, when the vehicle makes a turn, there are dead angles blocked at front by the two columns of the windshield of the vehicle, thus affecting the response and judgment of the drivers.

### BRIEF SUMMARY OF THE INVENTION

The present utility model provides a safety device that enables you to observe the dead area and angle.

The utility model adopts the following technical scheme:

a driving safety device, which comprising: at least two cameras set within the range defined from ⅓ front side of the engine hood to the rear side of the bumper bar; these two cameras are covered by a casing, and fixed at a relative location of the central axis of the vehicle body along with the casing; moreover, these two cameras cover separately the left and right sides in front of the vehicle, and also are linked to a controller in the vehicle, so as to display simultaneously images on the screen via the driving of the controller.

In the preferred embodiment, the utility model provides a driving safety device, which comprising: cameras installed at forwardmost location of the engine hood in relation to the rear side of the front bumper bar; these cameras cover separately the left and right sides in front of the vehicle; so when a vehicle is driven away from an alley, the images could be projected onto the onboard screen by the cameras without need of driving the vehicle abruptly out of the alley, thus allowing to learn the actual situations and status and provide an early warning against any unexpected operation that makes other drivers get scared. Also, the safety device could prevent traffic accident arising from failure of timely evasion or braking.

### BRIEF DESCRIPTION OF THE SEVERAL VIEWS OF THE DRAWINGS

FIG. 1: a top view of a driving safety device in the preferred embodiment of the utility model;

FIG. 2: an oblique view of a driving safety device in the preferred embodiment of the utility model;

FIG. 3: a lateral view of a driving safety device in the preferred embodiment of the utility model;

FIG. 4: a scenario view of a driving safety device in the preferred embodiment of the utility model;

FIG. 5: a top view of the preferred embodiment of the utility model that safety units are installed at front and rear of the driving safety device.

### DETAILED DESCRIPTION OF THE INVENTION

The driving safety device of the utility model is described in detail with reference to the accompanying drawings.

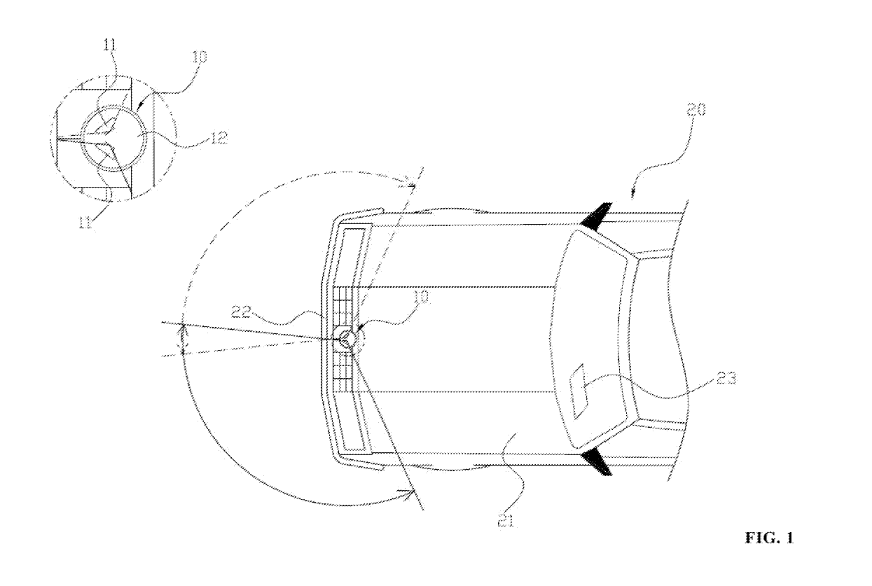

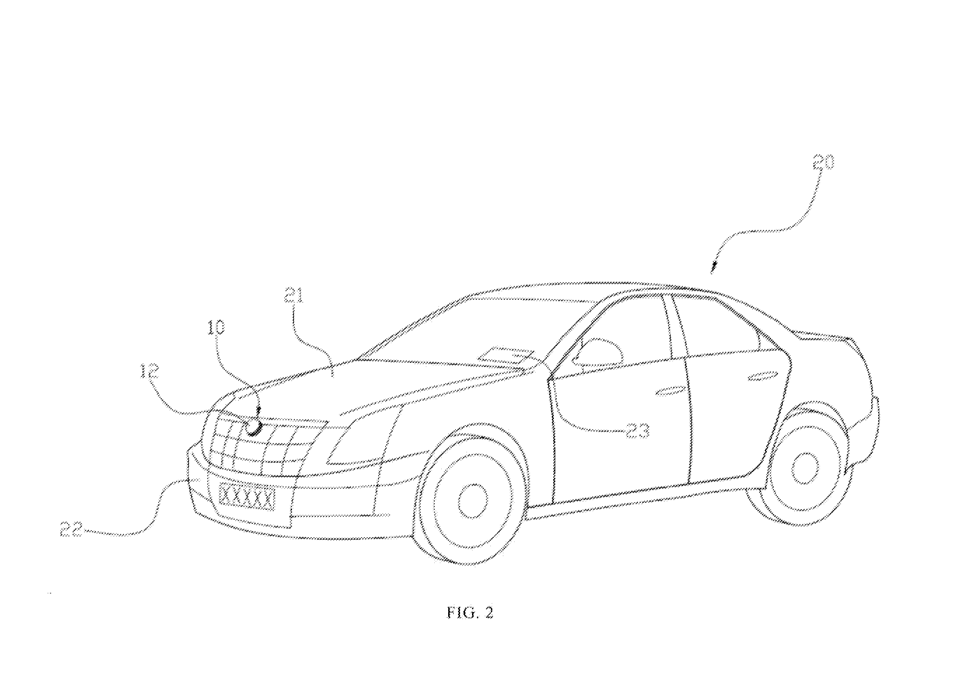

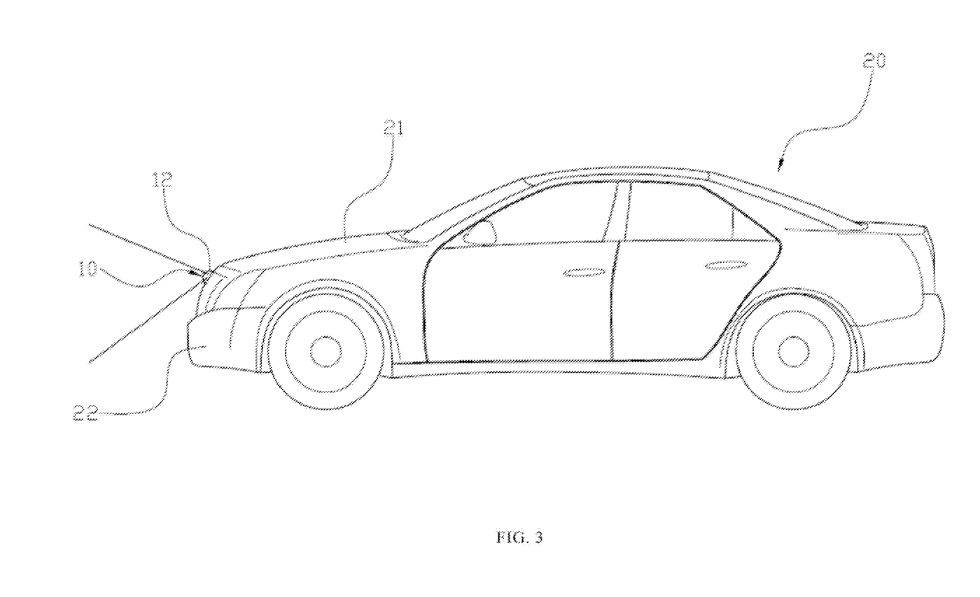

Referring to FIGS. 1, 2 and 3, said safety device 10 comprising: at least two cameras 11 (e.g.: pinhole camera) set within the range defined from ⅓ front side of the engine hood 21 to the rear side of the bumper bar 22: these two cameras 11 are covered by a casing 12, and fixed at a relative location of central axis of the vehicle body along with the casing 12; moreover, these two cameras 11 cover separately the left and right sides in front of the vehicle 20, with a sectorial covering range more than 180 degree via the overlapping of wide-angle lens; these two cameras 11 are linked to a controller in the vehicle, so as to display simultaneously images on the front windshield screen 23 of the vehicle 20 via the driving of the controller; moreover, said controller is provided with a large-capacity hard disc and various switching modes, enabling image storage when taking photographs. Hence, such multi-directional cameras 11 also serve as a driving recorder.

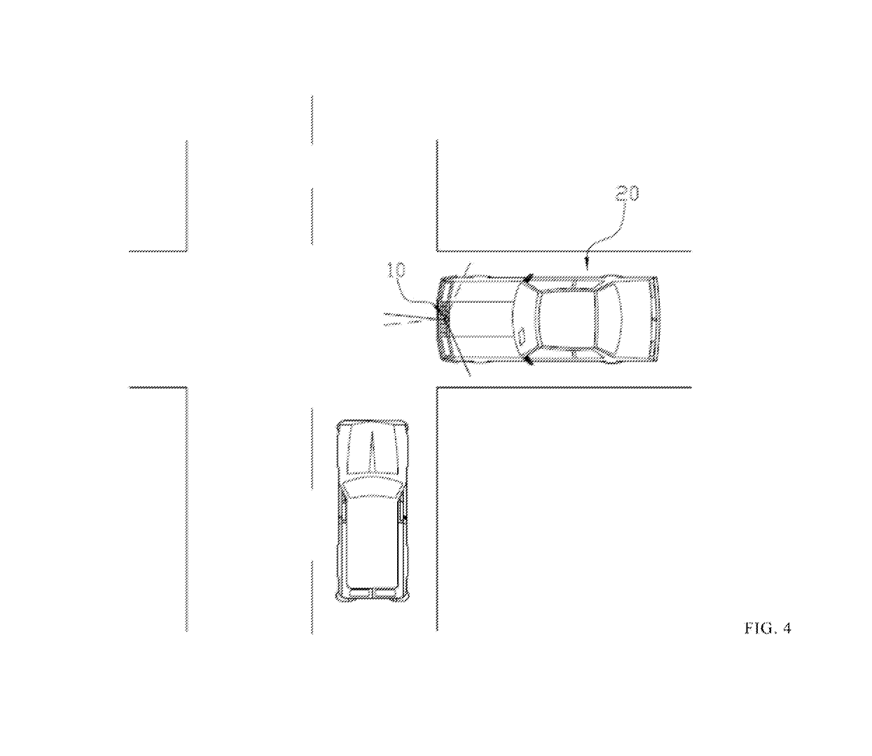

Based on above-specified structure, the safety device 10 is installed at forwardmost location of the engine hood 21 of the vehicle 20 in relation to the rear side of the front bumper bar 22, and two cameras 11 cover the left and right sides in front of the vehicle 20; so when you drive the vehicle 20 away from the alley, as shown in FIG. 4, you're not required to drive away the vehicle abruptly or even drive it away, but required to learn the actual situations and status according to the images projected on the screen 23 via the help of two cameras 11; this could prevent any abrupt operation that makes other drivers get scared. Also, the safety device could prevent traffic accident arising from failure of timely evasion or braking. When the vehicle 20 makes a turn, the road conditions behind the curve could still be projected by the cameras 11 onto the screen 23, providing an early warning to the driver; meanwhile, the safety device 10 could prevent dead angle formed due to blocking of visual lines by the columns, and also guarantee smooth turning against traffic accident.

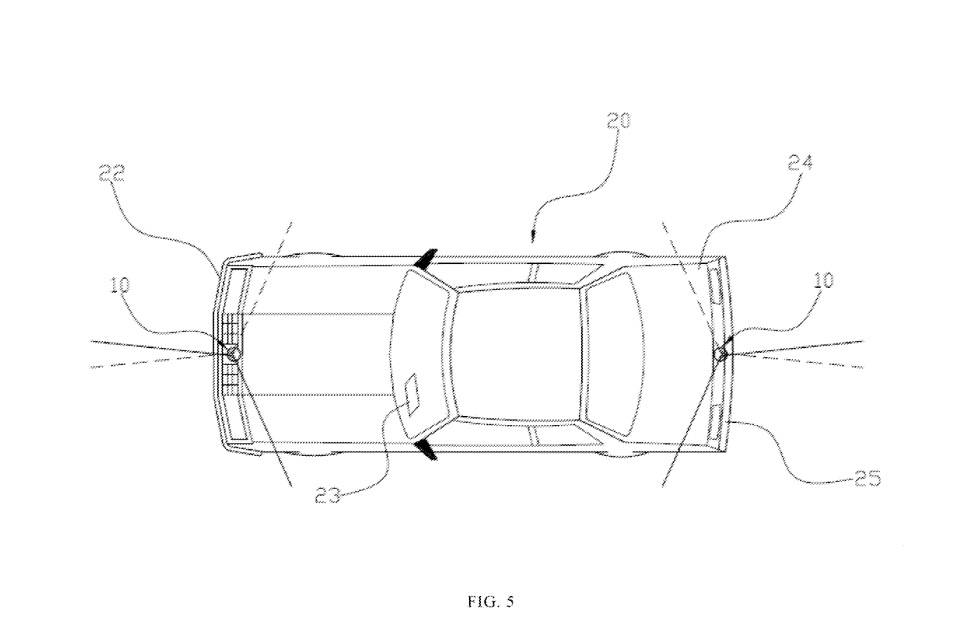

Referring to FIG. 5, the safety device 10 could also be installed at rearmost location of the baggage compartment lid 24 of the vehicle 20 in relation to the front of the rear bumper bar 25, such that the rear safety device 10 could be used simultaneously; in such case, the same degree of protection could be achieved when the vehicle 20 turns back or turns to leave from an alley; when the vehicle is switched to run forwards or backwards, the controller could be used to switch positively the front or rear image display mode, preventing the driver from diverting his/her attention; the screen 23 of the vehicle 20 is divided into several windows, enabling the driver to select a few cameras 11 at its own discretion and watch the images shown on the screen 23, or select a single camera 11 for individual display; and the screen 23 is preferably set below the front of the driver's seat, enabling the driver to receive the image information on the screen 23 only using the residual vision, with need of turning head or diverting attention.

Furthermore, after waterproofing treatment of the casing 12 of said safety device 10, the shape of the casing 12 can also be adjusted without prejudice of the irradiation besides, the safety device 10 can be combined with various vehicle brands and versions, bringing about a more aesthetically pleasing appearance.

In the preferred embodiment, the utility model provides a driving safety device, wherein cameras are installed at forwardmost location of the engine hood in relation to the rear side of the front bumper bar; these cameras cover the left and right sides in front of the vehicle, so when a vehicle is driven away from an alley, the images could be projected onto the inboard screen by the cameras without need of driving the vehicle abruptly out of the alley, thus allowing to learn the actual situations and status and provide an early warning against any unexpected operation that makes other drivers get scared. Also, the safety device could prevent traffic accident arising from failure of timely evasion or braking.

Although the invention has been explained in relation to its preferred embodiment, it is to be understood that many other possible modifications and variations can be made without departing from the spirit and scope of the invention as hereinafter claimed.

1. A driving safety device, comprising: at least two cameras set within the range defined from the front side of an engine hood to the rear side of a bumper bar; these two cameras are covered by a casing, and fixed at a relative location of a central axis of the vehicle body along with the casing; these two cameras cover separately the left and right sides in front of the vehicle, and also are linked to a controller in the vehicle, so as to display simultaneously images on the screen via the driving of the controller.

2. The device defined in claim 1, wherein said screen is set on the front windshield glass of the vehicle.

3. The device defined in claim 1, wherein said screen is divided into several windows, enabling to display the images from at least two cameras or from a single camera.

4. The device defined in claim 1, wherein said screen is set on the front windshield glass below the front of the driver's seat.

5. The device defined in claim 1, wherein said controller is provided with a large-capacity hard disc.

6. The device defined in claim 1, wherein the casing of said safety device is subjected to waterproofing treatment.

7. The device defined in claim 1, wherein said safety device allows adjusting the shape of casing according to the vehicle types.

8. The device defined in claim 1, wherein said casing can be combined with various vehicle brands and versions.

9. The device defined in claim 1, wherein said safety device is also installed at rear end of the vehicle.

10. The device defined in claim 1, wherein said camera is a pinhole camera with wide-angle lens.
